(19) United States
(12) Patent Application Publication
(10) Pub. No.: US 2003/0112136 A1
(43) Pub. Date: Jun. 19, 2003

(54) Tire pressure warning device

(76) Inventor: Rodney B. Reidhead, Scottsdale, AZ (US)

Correspondence Address: Christopher J. McDonald, Esq., HOFFMAN, WASSON & GITLER, PC, Suite 522, 2361 Jefferson Davis Highway, Arlington, VA, 22202, US

(21) Appl. No.: 10/014,594

(22) Filed: Dec. 14, 2001

(51) Int. Cl. B60C 23/00

(52) U.S. Cl. 340/442

(57) ABSTRACT

A tire pressure warning device has a plunger slidable within a housing. The sliding of the plunger is controlled by the amount of air pressure supplied by the tire. A spring biases the plunger toward sensors in the housing. Sufficient tire pressure in the tire serves to keep the plunger spaced from the sensors. When insufficient pressure is applied by the tire, the spring moves the plunger against sensors to indicate a warning condition. Further reduction in tire pressure causes the plunger to move further and trigger an emergency condition.

### FIELD OF THE INVENTION

The invention relates to a device for warning a driver of a vehicle, such as a multi-axle truck, of insufficient tire pressure.

### BACKGROUND OF THE INVENTION

Insufficient tire pressure reduces fuel economy of a vehicle as well as shortens the useful life of a tire. Pressure changes in a tire with the ambient temperature. Therefore, as the seasons change, the pressure within tires also changes. There is also the possibility of a minute air leak within a tire that will slowly reduce the tire air pressure. Manually operated tire gauges measure tire pressure so that the driver can optimize the pressure by supplying pressure from an air hose, at a gas station, fuel depot, weighing station, or the like.

Devices in the prior art are known to continually monitor tire pressure. Such devices often are attached to the tire stem, in a permanent or semi-permanent fashion. One such device is disclosed in U.S. Pat. No. 3,713,092 (Ivenbaum). Ivenbaum discloses a self-contained radio transmitter in a housing attached to the inflation stem of a vehicle tire. A pressure responsive switch, responsive to pressure in a controlled pressure compartment of the housing, moves to energize the transmitter upon sensing a predetermined pressure differential between the control compartment and the vehicle tire.

U.S. Pat. No. 6,163,255 (Banzhof et al) discloses a snap in valve including a valve body surrounded by a resilient element forming an annular sealing surface snapping into a valve opening of a wheel. A radio frequency sending unit with a column extending from the sending unit mounts to the valve body. The resilient element and the pressure sending unit form an expansion volume chamber between them.

There is a need for a tire pressure sensor having a first warning condition when low pressure in the tire being monitored, is detected, and a second emergency condition when the pressure falls to a second, lower pressure that, if not rectified, may lead to tire damage, or even failure.

It is an object of the invention to provide a tire pressure warning device that can be added to any existing tire.

It is another object of the invention to provide a tire pressure warning device that is simply attached and detached from a vehicle tire.

It is yet another object of the invention to provide a tire pressure warning device that has a first warning condition and a second emergency condition.

It is still another object of the invention to provide a tire pressure warning device that is simple to use and inexpensive to manufacture.

It is another object of the invention to provide a tire pressure gauge that may be calibrated for a specific tire's proper pressure.

These and other objects of the invention will become apparent after reviewing the disclosure of the invention.

### SUMMARY OF THE INVENTION

A tire pressure warning device has a plunger slidable within a housing. The sliding of the plunger is controlled by the amount of air pressure supplied by the tire. A spring biases the plunger toward sensors in the housing. Sufficient tire pressure in the tire serves to keep the plunger spaced from the sensors. When insufficient pressure is supplied by the tire, the spring moves the plunger against sensors to indicate a warning condition. Further reduction in tire pressure causes the plunger to move further and trigger an emergency condition. The tire pressure warning device is attached to the valve stem of a tire and remains attached to provide continuous monitoring of the tire's pressure.

### BRIEF DESCRIPTION OF THE DRAWINGS

FIG. 1 is a cross sectional view of the tire pressure warning device;

FIG. 2 is an exploded view of the tire pressure warning device; and

FIG. 3 is a side view of the transmitter used in the device.

### DETAILED DESCRIPTION OF THE INVENTION

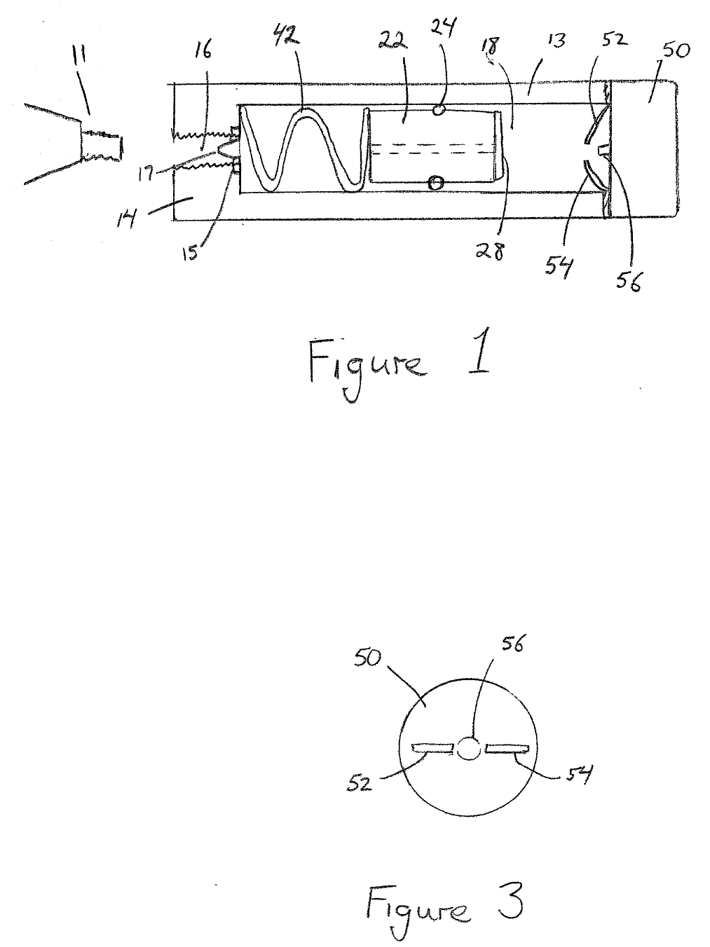

FIG. 1 depicts the tire pressure warning device. The device has a housing 12 formed by a side wall 13 and bottom wall 14. A threaded bore 16 for attaching the device to a vehicle tire valve stem is provided in the bottom wall. A depression nipple 17 with a slot and hole machined in its middle, needs to depress the core of the valve stem 11 to allow air to enter the housing. A seal ring 15 creates an air tight seal between the valve stem 11 and the housing 12. The side wall 13 and bottom wall 14 form a chamber 18.

A plunger 22 fits within the chamber 18. An O-ring 24 forms a seal between the plunger and the housing side wall 13. A central bore extends through the center of the plunger and a metal contact plate 28 is attached to the right end of the plunger.

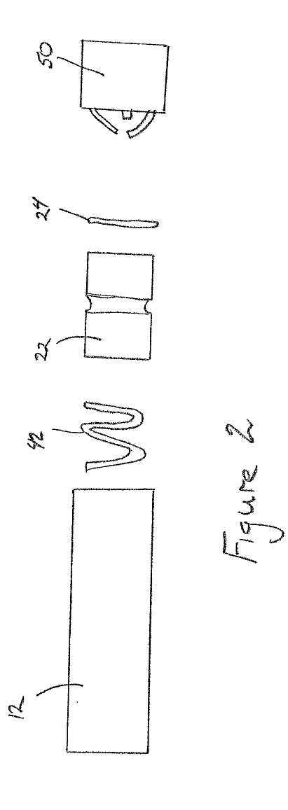

A spring 42 extends between the housing bottom wall 14 and the left end of the plunger 22. The spring biases the plunger away from the bottom wall. The device can be calibrated for different tires, each having different correct tire pressures, by changing the spring. A transmitter 50 attaches to the right end of the side wall 13 and seals thereto to close the chamber 18. The transmitter contains a battery power source. The transmitter 50 has a positive contact 52 and a negative contact 54 for grounding the transmitter. An emergency warning positive contact 56 extends from in the middle of the left face of the transmitter 50. The various parts are clearly seen in the exploded view of FIG. 2.

The device screws onto the valve stem creating a tight seal. The device remains attached to the valve stem to provide the driver with a continuous monitoring of the tire pressure. At the correct pressure, the plunger is held away from the contacts of the transmitter 50 against the bias of the spring 42. If air pressure in the tire decreases, the air pressure in the area between the plunger 22 and transmitter 50 decreases allowing the force from the spring 42 to push the plunger against the transmitter contacts. In a preferred embodiment, a decrease in pressure of 4-5 lbs. will cause the plunger to engage the contacts. The metal contact plate 28 on the plunger 22 serves as an electrical connection between the positive contact 52 and negative contact 54 after a decrease in pressure of four to five pounds within the tire. This condition sends a signal from the transmitter to a receiver, usually mounted on the dashboard of the vehicle. A caution signal is displayed to the driver.

Further decrease in the tire pressure causes the plunger to move further toward the transmitter. This allows the metal contact plate 28 to contact the shorter emergency warning positive contact 56, creating a circuit with the negative contact 54. The bowed contacts 52, 54 provide resistance that must be overcome before the emergency warning positive contact is activated. This ensures that the device does not have false positives. This causes another signal to be transmitted from the transmitter to the receiver designated an emergency warning to the driver. When the tire is returned to normal operating pressure, the plunger returns to a position spaced from the transmitter breaking contact between the positive and negative contacts of the transmitter.

While the invention has been described with reference to a preferred embodiment, variations and modifications would be apparent to one of ordinary skill in the art. For instance, the plunger 22 may not have a metal contact plate and cause the positive contact 52 and negative contact to touch each other. Also, a separate negative contact can be provided for the emergency warning positive contact 56. The invention encompasses such variations and modifications which do not depart from the scope of the invention.

I claim:

1. A tire pressure warning device, comprising:
a housing for attachment to a tire valve stem, said housing having at least one side wall and bottom wall defining a chamber,
a plunger slideably disposed in said chamber,
a transmitter attached to said at least one side wall and forming a top wall,
a first positive contact connected to said transmitter and extending into said chamber,
a first negative contact connected to said transmitter and extending into said chamber,
a second positive contact connected to said transmitter and extending into said chamber,
a spring positioned between said bottom wall and said plunger for biasing said plunger towards said transmitter.

2. The tire pressure warning device of claim 1, further comprising an O-ring about said plunger for forming a seal between said plunger and said at least one side wall.

3. The tire pressure warning device of claim 1, wherein said housing is cylindrical.

4. The tire pressure warning device of claim 1, further comprising a threaded bore in said bottom wall for attaching said housing to a tire valve stem.

5. The tire pressure warning device of claim 1, wherein said spring is a coil spring.

6. The tire pressure warning device of claim 1, further comprising electrical connection between said first positive contact and said first negative contact.

7. The tire pressure warning device of claim 1, wherein said first positive contact extends into the chamber a greater distance than said second positive contact.
